(19) United States
(12) Patent Application Publication
(10) Pub. No.: US 2006/0064388 A1
(43) Pub. Date: Mar. 23, 2006

(54) Method and system for the total decoupling of licenses from associated license protected configuration

(75) Inventors: Andreas Wannenwetsch, Dusseldorf (DE); Thomas Nagelkramer, Kuerten (DE); Jurgen Opschroef, Straelen (DE); Daniel Fuhrmann, Koln (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/017,769

(22) Filed: Dec. 22, 2004

(30) Foreign Application Priority Data
Sep. 22, 2004 (EP) 04 022 586.4

(51) Int. Cl. G06Q 99/00

(52) U.S. Cl. 705/59

(57) ABSTRACT

An operating method uses at least one element having at least one license protected system feature, a management tool, a management agent, and a license management element. The method includes a configuration procedure and a license deployment procedure. The configuration procedure includes sending commands for the configuration of the license protected system feature from the management tool to the management agent, and executing the configuration of the license protected system feature by the management agent. The license deployment procedure includes sending command for the download of the license from the management tool to the management agent and downloading it correspondingly. The license protected system feature is enabled only if both the configuration procedure and the license deployment procedure have been duly executed.

### FIELD OF THE INVENTION

The present invention relates to a method and system for the total decoupling of licenses from associated license protected configuration. In particular, the present invention relates to an operating method and a management system as well as a managed system suited therefor.

### RELATED BACKGROUND ART

The background of the present invention is the field of systems including elements having license protected system features (as well as system features which are not license protected, of course). Such a system feature is a specific functionality of the system, such as for instance on the field of communication systems, Asynchronous Transfer Mode (ATM) Adaptation Layer type 2 (AAL-2) multiplexing. The basic idea behind this kind of system features (i.e. the license protected ones) is to have a certain system feature protected by an associated license which can be priced in addition. The license protected system feature can be used if a valid license is available and cannot be used if no such valid license is available.

However, the management of licenses turns out to become a logistical process of its own, where customers buy licenses for certain system features they want to use, and the supplier provides these licenses after the agreed payment has been made. Since this process is still to be established, it is at present not possible to integrate it into other processes for the time being. Also in future times this remains to be a very challenging area. This is particularly true for the integration of the configuration management process and the license management process.

In known products it is required that a license is obtained first, before a license protected system feature can be used. Stated in other words, either there is a license (which may be some hardware to be connected) for the product present or, so that either the product can be used fully or not at all. This is also the strategy for many PC based software that require a license.

Some solutions are a bit smarter in a sense that they allow the usage of the license protected system feature for a certain amount of time, e.g. three days, or with a certain limit, e.g. you are not allowed to save before a license has been deployed. Most shareware products are based on this solution.

However, these implementations suffer from the drawback that particularly systems comprising many license protected system features are stiff and inflexible regarding the process of taking them into operation. One example for such a system are modern state-of-the-art communication systems where single network elements involve a rather huge number of configuration parameters.

### SUMMARY OF THE INVENTION

Therefore, it is an object of the present invention to overcome the above drawbacks of the prior art.

This object is solved according to what is set forth in the appended independent claims. Advantageous modifications are defined in the appended dependent claims.

In particular, one aspect of the present invention is an operating method using at least one element having at least one license protected system feature, and further using a management tool, a management agent, and a license management element, the method comprising a configuration procedure and a license deployment procedure; wherein the configuration procedure comprises: sending commands for the configuration of the license protected system feature from the management tool to the management agent, and executing the configuration of the license protected system feature by the management agent; wherein the license deployment procedure comprises: sending command for the download of the license from the management tool to the management agent and downloading it correspondingly, sending command for the validation of the license from the management agent to the license management element, and executing a validation process for the downloaded license by the license management element which, in case of a positive validation, persistently stores the license and notifies the license protected system feature about the presence of a valid license; wherein the configuration procedure and the license deployment procedure are independent of each other so that the order of their execution is arbitrary; and wherein the license protected system feature is enabled only if both the configuration procedure and the license deployment procedure have been duly executed.

According to a first modification, the license management element is observed for the status of the license, and in case of a negative validation, the license protected system feature is disabled.

In this case, the disablement may be made immediately effective. However, the configuration shall remain effective and the license protected system feature is enabled again after another license deployment procedure has been duly executed.

According to a second modification, the license protected system feature is enabled immediately after the due execution of the lastly executed procedure out of the configuration procedure and the license deployment procedure.

According to a third modification, the management agent uses a configuration management element for the execution of the configuration of the license protected system feature.

According to a fourth modification, the management tool comprises a first element and a second element, wherein the first element executes the steps of the configuration procedure which are related to the management tool, while the second element executes the steps of the license deployment procedure which are related to the management tool.

Another aspect of the present invention is a managed system having a management agent, a license management element, and a configuration management element attending at least one license protected system feature, and wherein the management agent is configured to receive commands to distribute and to delete a license upon different triggers, to interrogate the status of a license as well as to configure a license protected system feature through a respective connection; the management agent is operably connected with the configuration management element and the license management element, and configured to validate or invalidate licenses stored in the license management element; the license management element is configured to store a license persistently and to notify about a license validity; the configuration management element is configured to arrange for a configuration of a license protected system feature independent of the validity or the presence of a license, and to observe the license management element; and the configuration management element and the license management element comprise an operable connection with each other which is configured so that a license protected feature is notified about a status of a corresponding license and enabled only if the license is valid.

Still another aspect of the present invention is a management system comprising a management tool and a managed system having a management agent, a license management element, and a configuration management element attending at least one license protected system feature, and wherein the management tool is operably connected with the management agent and configured to distribute and to delete a license upon different triggers, to interrogate the status of a license as well as to configure the license protected system feature through a respective connection; the management agent is operably connected with the configuration management element and the license management element, and configured to validate or invalidate licenses stored in the license management element; the license management element is configured to store a license persistently and to notify about a license validity; the configuration management element is configured to arrange for a configuration of a license protected system feature independent of the validity or the presence of a license, and to observe the license management element; and the configuration management element and the license management element comprise an operable connection with each other which is configured so that a license protected feature is notified about a status of a corresponding license and enabled only if the license is valid.

According to the above, the configuration management and license management are strictly separated to provide the user with a maximum of flexibility to adapt any processes. For example, this maximum in flexibility does support the absolutely time critical rollout phase for new products where the presence of license protected system features are typical. This holds particularly true if such new products, i.e. systems, include many license protected system features.

That is, the separation of configuration management and license management as effected according to the present invention means that configuring a license protected system feature is not any more only possible after the corresponding valid license has been installed in the system to be configured. This means that a license has not to be deployed first, before the configuration is made, which otherwise can heavily influence already established processes.

For the user it is very beneficial to run the license and configuration management processes highly independent of each other. Thus, a solution is provided, where the configuration of license protected system features (and of course not licensed protected system features) can be made before and after the license is deployed to the system.

Stated in other words, according to the present invention, the configuration can be made also in the absence of a license. Still, the license protected system feature is fully configurable, but not enabled or taken into use. Only if the license is deployed, the already configured feature is actually taken into use without any further need to configure the license protected system feature. Also if the license file is deployed first and the configuration is made second, the feature is operational immediately. In addition, if the license is removed, the configuration remains, but is functional disabled or taken out of use. This is in particular a new aspect for cases where licenses need to be updated, since they are only valid for a fixed amount of time.

The embodiments of the present invention ensure that the configuration of a license protected system feature and the deployment of the associated license are separated totally to give the user full control over their processes to deploy configuration and licenses to their system elements including license protected system features. Only if a license is deployed on such a system element, the corresponding feature is actually enabled or taken into use. The configuration and deployment steps are separated and thus the user is in full control of the configuration.

Specifically, according to one embodiment of the present invention, the system is configured first, including license protected system features. That is, the license protected system feature is configured, but not yet enabled or taken into functional use. Thereafter, the license is deployed and the license protected system feature is immediately taken into use or enabled.

According to another embodiment of the present invention, the license is deployed first. Afterwards, the system is configured including the license protected system features. The license protected system feature is immediately taken into use.

According to still another embodiment, if the license file is removed, the license protected system feature is disabled or taken out of use, but the license protected system feature remains configured. It is then enabled or taken into use immediately after the license is deployed again.

### BRIEF DESCRIPTION OF THE DRAWINGS

More details, objects, features and advantages of the present invention will be apparent from the following detailed description of preferred embodiments thereof which is to be taken in conjunction with the accompanying drawings, in which:

FIG. 1 shows a management system for a license protected system feature according to one embodiment of the present invention;

FIG. 2 shows a sequence diagram illustrating an operating method according to another embodiment of the present invention; and

FIG. 3 shows a sequence diagram illustrating an operating method according to still another embodiment of the present invention.

### DETAILED DESCRIPTION OF THE PREFERRED EMBODIMENTS

As the preferred embodiments of the present invention, below are described exemplary implementations.

Dependent on the specific needs, the user can first configure the license protected system feature and afterwards deploy a license or vice versa. The accompanying drawings illustrate corresponding preferred embodiments of the present invention.

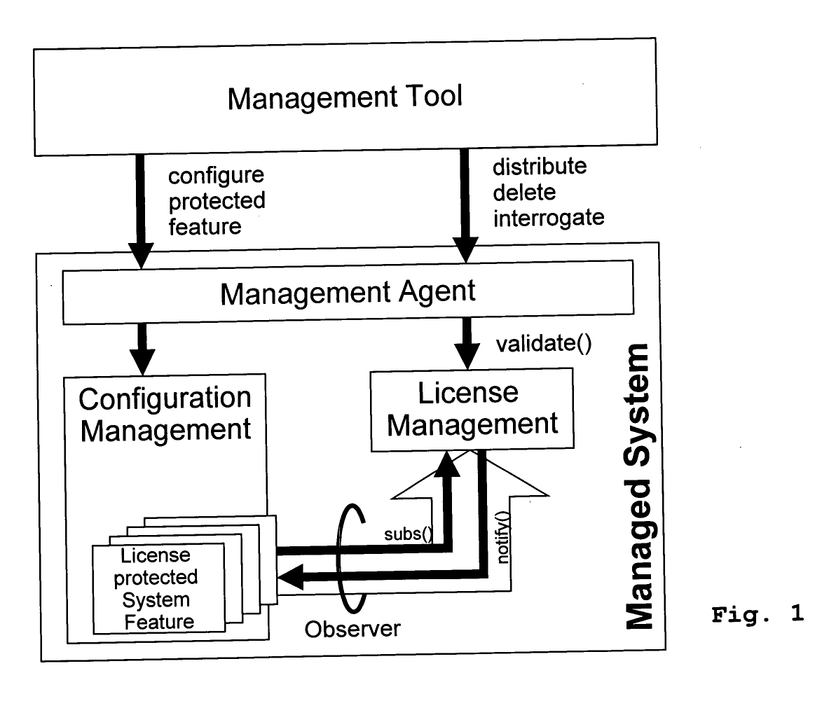

FIG. 1 shows a simplified picture of the license protected system feature management system according to one preferred embodiment of the present invention. This management system comprises a management tool and a managed system.

Specifically, a management tool is operably connected with a management agent. The configuration of this connection includes to configure license protected system features via the management agent as well as to initiate the distribution of licenses to the management agent, to initiate the deletion of licenses via the management agent and to initiate the interrogation of a license validity status.

According to certain embodiments of the present invention, the management tool need not be a physically closed unit. These embodiments include that the management tool is split in two so that there would be a license management tool comprising an operable connection with the management agent including a configuration to initiate the distribution of licenses to the management agent, to initiate the deletion of licenses via the management agent or to initiate the interrogation of a license validity status. Further, there would be a configuration management tool comprising another operable connection with the management agent including a configuration to configure license protected system features via the management agent.

A further embodiment is that there is a meta management tool providing a unitary appearance with respect to a user interface, although actually this meta management tool comprises the combination of the above described license management tool and configuration management tool.

The management agent is actually already part of the managed system and acts as interface towards the management tool as embodied according to the above described kinds.

Further, within the managed system, the management agent is operably connected with a configuration management element which is arranged to configure the system features including both system features without a license protection and license protected system features. As described above, configuration commands (to configure a license protected system feature) are initiated by the management tool towards the management agent which passes it on to the configuration management of a license protected system feature. According to the present embodiment, the license protected feature is configured independently of the presence (status) of a corresponding license.

In addition to the configuration management element, the managed system includes a license management element being also operably connected to the management agent. That is, the above described license management related commands (distribute, delete, interrogate) are initiated by the management tool towards the management agent which passes them on to the license management element. There, at the license management element, a license it either taken into use (distribute), taken out of use (delete), or the license status can be interrogated here.

Stated in other words, the management agent is operably connected with the license management element which is configured to store data persistently and to check the validity of a license.

Another operable connection is between the configuration management element/license protected system features and the license management element. According to one embodiment of the present invention, this connection includes a software pattern called Observer. The connection is configured so that during an initialization phase, a license protected system feature subscribes for the state and existence of a certain (corresponding) license. In turn, the license protected system feature gets informed/notified in case the state of the related license changes.

As described above, according to the present embodiment, the deployment and the deletion of the license can be executed independently of the configuration of the license protected system feature. The license protected system features observe during operation the status of the corresponding license by subscribing to the license management element. Dependent on the status of the related license (valid, not valid), the configured feature functionality is enabled/disabled.

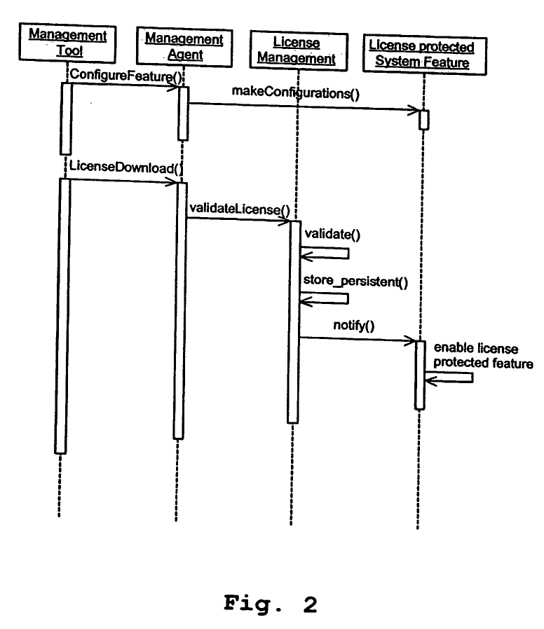

FIG. 2 shows a sequence diagram illustrating an operating method according to another embodiment of the present invention.

In detail, the method according to the present embodiment includes a configuration procedure which is constituted by sending a “ConfigureFeature( )” command from a management tool to a management agent which, in turn, sends a “makeConfigurations( )” command to a license protected system feature.

Further, the method according to the present embodiment includes a license deployment procedure which is constituted by sending a “LicenseDownload( )” command to the management agent. Then, the management agent sends a “validateLicense( )” command to a license management element which validates the license and stores successfully validated licenses persistently by running respective “validate( )” and “store_persistently( )” routines. The presence of a valid license is notified by the license management element to the license protected system feature.

With both the configuration and the license deployment procedures being thus duly executed, a respective routine enables the functionality corresponding to the license protected system feature.

That is, according to the present embodiment, the system is firstly configured including license protected system features which means that a license protected system feature is configured, but not yet enabled or taken into functional use. Only after a license is deployed, the license protected system feature is immediately taken into use or enabled.

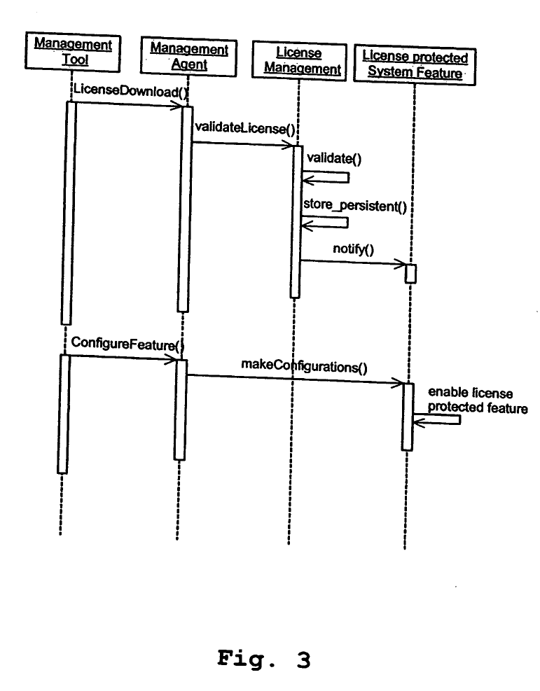

FIG. 3 shows a sequence diagram illustrating an operating method according to still another embodiment of the present invention.

According to the present embodiment, the above described procedures are executed in reverse order, i.e. a license deployment procedure is executed first, followed by a configuration procedure. Incidentally, the procedures itself are constituted as described above. Again, after both procedures being duly executed, a respective routine at the license protected system feature enables the license protected functionality thereof.

That is, according to the present embodiment, a license is deployed at first, while the system is configured only thereafter, including a license protected system feature. The license protected system feature is then immediately taken into use or enabled.

As is readily apparent to the skilled reader, the above described preferred embodiments include modifications where more than one license protected system feature is present, e.g. a plurality.

According to embodiments of the present invention, the configuration management and the license management are totally decoupled, and thus it is possible to keep the logistical process for license delivery as an independent process. However, if required, it can also be combined easily with any other delivery process if required. In addition, due to this flexibility, it can be fully time optimized and enables to keep a product rollout fast where license protected system features are included. This is one of the key advantages that is required to make license management acceptable for any user.

Implementations of the present invention as embodiments thereof include any field where license protected system features are used. For example, as one field of current interest, the Universal Mobile Telecommunications System (UMTS) is addressed, where, especially in the Radio Access Network (RAN), many thousand network elements need to be configured and thus benefit from this total decoupling and gained flexibility.

Included in the above description is an operating method using at least one element having at least one license protected system feature, and further using a management tool, a management agent, and a license management element, the method comprising a configuration procedure and a license deployment procedure; wherein the configuration procedure comprises: sending commands for the configuration of the license protected system feature from the management tool to the management agent, and executing the configuration of the license protected system feature by the management agent; wherein the license deployment procedure comprises: sending command for the download of the license from the management tool to the management agent and downloading it correspondingly, sending command for the validation of the license from the management agent to the license management element, and executing a validation process for the downloaded license by the license management element which, in case of a positive validation, persistently stores the license and notifies the license protected system feature about the presence of a valid license; wherein the configuration procedure and the license deployment procedure are independent of each other so that the order of their execution is arbitrary; and wherein the license protected system feature is enabled only if both the configuration procedure and the license deployment procedure have been duly executed.

Although it has been described above what is presently considered to be preferred embodiments of the present invention, it is fully apparent to those who are skilled in the art that various modifications of and combinations among the above described preferred embodiments are possible without deviating from the spirit and scope of the present invention as defined by the appended claims.

1. An operating method using at least one element having at least one license protected system feature, and further using a management tool, a management agent, and a license management element, the method comprising:
executing a configuration procedure and a license deployment procedure;
a) wherein the configuration procedure includes
sending commands for a configuration of a license protected system feature from a management tool to a management agent, and
executing the configuration of the license protected system feature by the management agent;
b) wherein the license deployment procedure includes:
sending a first command for a download of a license from the management tool to the management agent and downloading the license correspondingly,
sending a second command for validation of the license from the management agent to a license management element, and
executing a validation process for the license by the license management element which, in case of a positive validation, persistently stores the license and notifies the license protected system feature about the presence of a valid license;
c) wherein the configuration procedure and the license deployment procedure are independent of each other so that an order of execution is arbitrary; and
d) wherein the license protected system feature is enabled only if both the configuration procedure and the license deployment procedure have been duly executed.

2. The method according to claim 1, wherein said executing said validation process comprises observing the license management element for a status of the license, and in case of a negative validation, disabling the license protected system feature.

3. The method according to claim 1, further comprising enabling the license protected system feature after the due execution of a lastly executed procedure of the configuration procedure and the license deployment procedure.

4. The method according to claim 2, wherein the disabling comprises disabling said license protected system feature immediately.

5. The method according to claim 4, further comprising keeping a configuration according to the configuration procedure effective and enabling the license protected system feature again after another license deployment procedure has been duly executed.

6. The method according to claim 1, wherein said executing the configuration comprises using a configuration management element for the execution of the configuration of the license protected system feature by the management agent.

7. The method according to claim 1, wherein the management tool comprises a first element and a second element, and wherein the first element executes the steps of the configuration procedure that are related to the management tool, and the second element executes the steps of the license deployment procedure that are related to the management tool.

8. A managed system having a management agent, a license management element, and a configuration management element attending to at least one license protected system feature, and wherein
the management agent is configured to receive commands to distribute and to delete a license upon different triggers, to interrogate a status of the license and to configure a license protected system feature through a respective connection,
wherein the management agent is operably connected with the configuration management element and the license management element, and configured to validate or invalidate licenses stored in the license management element;
the license management element is configured to store the license persistently and to notify about a license validity; and
the configuration management element is configured to arrange for a configuration of the license protected system feature independent of the validity or a presence of the license, and to observe the license management element;
wherein the configuration management element and the license management element comprise an operable connection with each other which is configured so that the license protected system feature is notified about the status of the license and enabled only if the license is valid.

9. A management system comprising a management tool and a managed system having a management agent, a license management element, and a configuration management element attending to at least one license protected system feature, and wherein
the management tool is operably connected with the management agent and configured to distribute and to delete a license upon different triggers, to interrogate a status of the license and to configure a license protected system feature through a respective connection;
wherein the management agent is operably connected with the configuration management element and the license management element, and configured to validate or invalidate licenses stored in the license management element;
the license management element is configured to store the license persistently and to notify about a license validity; and
the configuration management element is configured to arrange for a configuration of the license protected system feature independent of the validity or a presence of the license, and to observe the license management element;
wherein the configuration management element and the license management element comprise an operable connection with each other which is configured so that the license protected system feature is notified about a status of the license and enabled only if the license is valid.

10. An operating method for a system, the method comprising:
executing a configuration procedure by
sending commands for a configuration of a license protected system feature from a management tool to a management agent, and
executing the configuration of the license protected system feature by the management agent;
executing a license deployment procedure by
sending a first command to download the license from the management tool to the management agent,
sending a second command for validation of the license from the management agent to a license management element, and
executing a validation process for the license by the license management element that persistently stores the license for a positive validation and notifies the license protected system feature about a presence of a valid license; and
enabling the license protected system feature if the configuration procedure and the license deployment procedure is executed.
